(19) United States
(12) Patent Application Publication
(10) Pub. No.: US 2002/0165747 A1
(43) Pub. Date: Nov. 7, 2002

(54) Supply chain visibility system and method

(75) Inventors: Joseph Lee Shriver, Granite Falls, WA (US); Roger A. Parry, Kent, WA (US); James H. Webber, Federal Way, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Seattle, WA (US)

(21) Appl. No.: 09/846,424

(22) Filed: May 1, 2001

(51) Int. Cl. G06F 17/60

(52) U.S. Cl. 705/8

(57) ABSTRACT

A supply chain visibility system having a plurality of graphical user interfaces and a processing element is provided. Each graphical user interface includes a plurality of panels for interacting with suppliers and recipients of the supply chain. Each graphical user interface includes configuration panels for presenting a proposed configuration and for releasing changes to the proposed configuration along with a set of delivery due dates for the parts used to assemble the final assembly. A statement of work panel reports the shipping status of the parts used to assemble the final assembly. A delinquent parts panel lists those parts that have not been received by their due dates. A return for repair and a replacement panels receive information on parts that must be returned or replaced due to loss or damage. An email dispatch system alerts supply chain participants to entries and changes made to the configuration and the shipping status of the parts.

### FIELD OF THE INVENTION

The present invention relates to the field of supply chain management systems and methods, more particularly supply chain management systems and methods using a network such as the Internet.

### BACKGROUND OF THE INVENTION

Supply chain management systems seek to control the flow of parts and services amongst suppliers and to an endpoint recipient for final assembly into a finished product. Extremely complex products, such as aircraft, can have thousands of parts coming from dozens of individual suppliers. Such a large number of suppliers and parts makes supply chain management difficult. This is especially true when the parts or services are order dependent, i.e., certain steps of the assembly process must be performed before other steps can be begun or completed. Delays can result in lost work hours due to idle employees and lost revenue as a result of decreased production efficiency.

The logistics of most supply chain management consists of procurement agents (or “buyers”) working for the recipient that review paper documentation, such as bills of lading, and compare that documentation to a master parts list. The procurement agents look for parts that have not yet been received and seek to determine the status of various missing or time-critical parts by communicating with the suppliers. One supplier's ability to supply the missing parts may depend upon the fulfillment of orders by other suppliers. Therefore, the chain of phone calls and other communications that must be placed, received and responded to in order to determine the status of any one missing part grows exponentially with the complexity of the final product.

U.S. Pat. No. 5,960,408 to Martin et al. discloses an on-time delivery system that tracks and reports product delivery dates. A supplier maintains a customer preference database having delivery and reporting preferences, including early and late delivery limits. A customer enters a preferred delivery date when ordering the product. The delivery system uses the customer-entered delivery date and the customer delivery preferences to determine a targeted ship date window. The targeted ship date window allows the supplier to plan its production of the product so as to be able to ship within the ship date window. Although the on-time delivery system taught by Martin et al., has the advantage of facilitating communication between supplier personnel and the procurement agent, the system fails to address the problem of multiple suppliers in a chain needing to communicate with each other and the recipient.

Complex products, such as aircraft, are commonly customized to meet the needs of an individual purchaser. Therefore, a purchase order cannot be merely duplicated from the production of a similar product and dispatched for fulfillment by the suppliers of the supply chain. Each configuration must be modified to suit the needs of the customer and agreed upon by the suppliers and the recipient manufacturer before distribution of the purchase orders. The initial determination of a configuration is difficult and time consuming as it requires the agreement of potentially dozens of suppliers. Especially problematic is the effect of downstream changes to the configurations that occur for various reasons, such as problems encountered with the failure of individual parts. Deviations in the standard configuration, along with the number of parts involved in the manufacture of complex products, make it difficult for many suppliers to determine what their exact responsibilities are in the supply chain.

U.S. Pat. No. 5,311,424 to Mukherjee et al. addresses the problem of multiple product configurations by disclosing a system for defining a product configuration and tracking changes to that product configuration. Customer contracted views of the product are defined by applying temporary changes to a base product configuration. A product serial number effectivity is assigned to each unique customer specified product configuration and to the base product. The configuration is used to peg detail component requirements to the serially numbered products to be used with conventional inventory management processes. Despite disclosing a system that accounts for changes in product configuration, Mukherjee et al. fails to teach how the changes are communicated to the appropriate suppliers with sufficient clarity to ensure proper maintenance of the supply chain.

Therefore, it would be desirable to have a supply chain system and method that provides for more effective communication between suppliers and recipients, thereby rendering the supply chain more efficient and reliable. A supply chain system and method is also needed that accounts for changes in configuration and that effectively communicates those changes to the suppliers. It would also be advantageous if each supplier were able to ascertain what their exact responsibilities were in the supply chain.

### SUMMARY OF THE INVENTION

The present invention addresses the above needs and achieves other advantages by providing a supply chain visibility system and method having network-accessible, graphical user interfaces to facilitate communications between a plurality of suppliers and at least one recipient so as to determine a final configuration of an assembly and to coordinate a supply chain of the parts to be assembled into the assembly. Each graphical user interface is capable of presenting a group of configuration panels that release a proposed configuration for negotiation among the suppliers and recipient, change the proposed configuration pursuant to the negotiation and finalize the configuration for distribution in a purchase order. Each graphical user interface is also capable of presenting a statement of work panel to display a final set of parts of the final assembly and the shipping status of the final set of parts.

The supply chain visibility system and method coordinates a supply chain of a plurality of parts to be assembled into a finished assembly for each of a plurality of unfinished products known as effectivities. The parts are supplied by a plurality of suppliers and are received by at least one recipient. The supply chain system and method includes a plurality of graphical user interfaces and a processing element. Each graphical user interface is associated with a respective supplier or with a recipient and is connected to the other graphical user interfaces via the network. The graphical user interface is capable of presenting a configuration panel operable to display a final configuration agreed to by the suppliers and at least one recipient. The final configuration defines at least a portion of a finished assembly for which the parts need to be shipped.

A template panel is also presented by each graphical user interface and is operable to display a common set of parts that are common to each of the plurality of effectivities. The common set of parts are also those parts necessary to assemble the final configuration. Each graphical user interface is capable of presenting a statement of work panel that is operable to display a final set of parts for each effectivity. The final set of parts for each effectivity are derived from the common set of parts which are applied, or exploded, across each effectivity. The statement of work panel is also operable to display a shipping status of the final set of parts. A shipment entry panel presented by each graphical user interface is configured to receive shipping status data from the suppliers and the recipient. The shipping status data is usable to update the shipping status of the final set of parts. The processing element compares the shipping status data received by the shipment entry panel to the shipping status of the final set of parts and updates the shipping status of the final set of parts. The update ensures that the suppliers and the recipient have an ongoing view of the current shipping status of the final set of parts. The ongoing view allows the assembly of the finished assembly to be planned accordingly. another aspect, the supply chain visibility system and method includes an electronic mail dispatch system that dispatches electronic mail messages that relate to changes in the shipping status of the final set of parts. The statement of work panel can include a plurality of fields displaying the shipping status, including a part number, shipping date and receipt date of each of the final set of parts. In yet another aspect, the shipping status further includes discrepancy information on parts received but found to be inadequate by at least one of the recipient and the receiving supplier.

The supply chain visibility system and method of the present invention advantageously makes allowances for damaged or missing parts. Each graphical user interface may be capable of presenting a return part panel that receives repair information and updates the statement of work panel with the repair information. Each graphical user interface may also present a replacement part panel that receives information on parts that need to be replaced and updates the statement of work panel with the replacement information.

The supply chain visibility system and method also informs the parties of parts that are delinquent or due dates that have been revised. In one aspect, each graphical user interface is capable of presenting an estimated completion date panel. The estimated completion date panel receives revised completion dates for supply of one, or more, of the parts. The revised completion date is added to the shipping status of the statement of work panel. In yet another aspect, each graphical user interface is capable of presenting a delinquency panel that displays a list of late parts that have failed to arrive by their due dates.

In yet another aspect, the supply chain visibility system includes an email dispatch system that dispatches emails communicating changes or entries into the panels of each graphical user interface.

The supply chain visibility system and method provides for the negotiation and finalization of a configuration with a list of parts that need to be supplied. In one aspect, each graphical user interface is capable of present a proposed configuration panel that displays an initial configuration proposed by one or all of the suppliers before an initial technical meeting. Each graphical user interface can also present a configuration release panel for changing the proposed configuration and finalizing the proposed configuration.

The supply chain visibility system and method of the present invention have several advantages. Improved visibility and real-time updates of the shipping status of various parts allows better management of the supply chain. The system and method advantageously combine both the creation of a configuration and the tracking of the parts of the configuration in a single system widely accessible over a network by a plurality of users. Delinquent and in transit parts can be easily identified to improve organization of work flow by the recipient and suppliers. Heads-up communication is ensured by email notification after every change or entry using the supply chain visibility system and method.

### BRIEF DESCRIPTION OF THE DRAWINGS

Having thus described the invention in general terms, reference will now be made to the accompanying drawings, which are not necessarily drawn to scale, and wherein:

FIG. 1 is a process flow diagram of a supply chain visibility system and method of one embodiment of the present invention;

FIG. 2 is a pre-ITCM configuration panel of the supply chain visibility system shown in FIG. 1;

FIG. 3 is a post-ITCM confirmation panel of the supply chain visibility system shown in FIG. 1;

FIG. 4 is a final template panel of the supply chain visibility system shown in FIG. 1;

FIG. 5 is a shipment data panel of the supply chain visibility system shown in FIG. 1;

FIG. 6 is a receipt data panel of the supply chain visibility system shown in FIG. 1;

FIG. 7 is a return-for-repair panel of the supply chain visibility system shown in FIG. 1;

FIG. 8 is a replacement panel of the supply chain visibility system shown in FIG. 1;

FIG. 9 is a new parts list panel of the supply chain visibility system shown in FIG. 1;

FIG. 10 is a post-ITCM update panel of the supply chain visibility system shown in FIG. 1;

FIG. 11 is a flow diagram of an ITCM process of the supply chain visibility system and method shown in FIG. 1;

FIG. 12 is an estimated completion date panel of the supply chain visibility system shown in FIG. 1;

FIG. 13 is a history of shipments panel of the supply chain visibility system shown in FIG. 1;

FIG. 14 is a shipments in transit panel of the supply chain visibility system shown in FIG. 1;

FIG. 15 is a delinquent shipment panel of the supply chain visibility system shown in FIG. 1;

FIG. 16 is a cross-reference panel of the supply chain visibility system shown in FIG. 1;

FIG. 17 is a flow diagram of a shipment data entry process of the supply chain visibility system and method shown in FIG. 1;

FIG. 18 is a diagram of the supply chain visibility system of one embodiment of the present invention;

FIG. 19 is a post-ITCM final configuration panel of the supply chain visibility system and method shown in FIG. 1;

FIG. 20 is a SOW effectivity panel of the supply chain visibility system and method shown in FIG. 1;

FIG. 21 is a SOW configuration change panel of the supply chain visibility system and method shown in FIG. 1; and

FIG. 22 is a second receipt data panel of the supply chain visibility system and method shown in FIG. 1.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

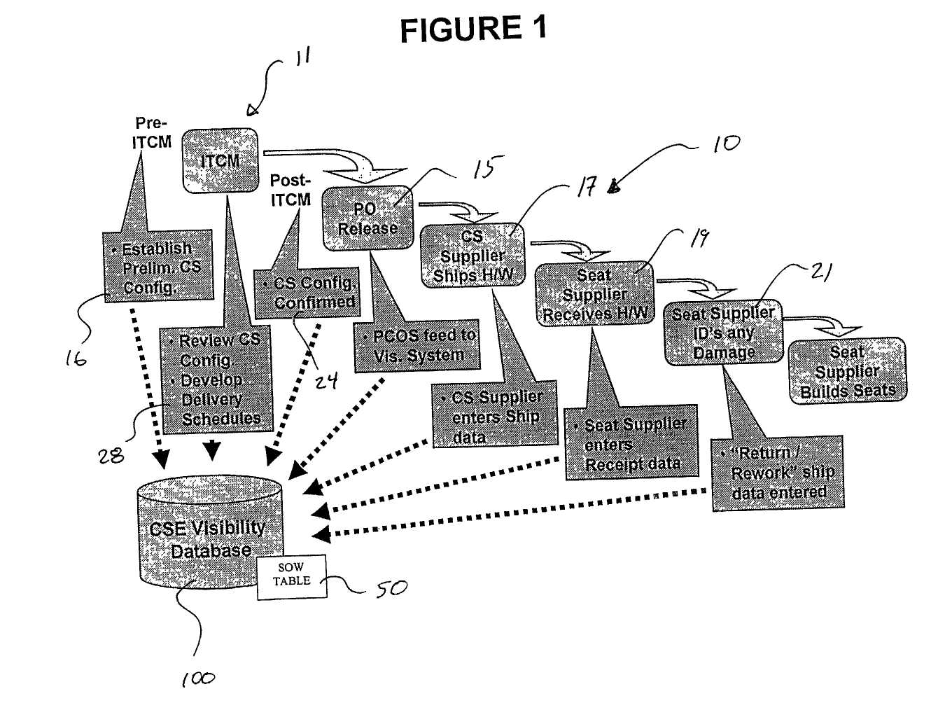

Referring to the steps defined by the flowchart in FIG. 1, the present invention includes a supply chain visibility system and method 10 that uses a plurality of graphical user interfaces that present web pages or other displays that are delivered via a network, such as the Internet, and that are generated by a computer based upon data contained by a visibility database 100 to coordinate a supply chain of a plurality of parts to be assembled into a finished assembly. The plurality of parts are supplied by a group of suppliers to a recipient, or recipients, for final assembly into multiple products, such as a fleet of airplanes, referred to as effectivities. A purchasing agent (PA) that typically works for the recipient, or other downstream customer, manages the database 100 and an associated computer system 150 that produces and delivers the web pages via the network to the plurality of graphical user interfaces 101. In this regard, each participant, i.e., each supplier and the recipient, preferably has a computer for accessing the network and an associated display which may serve as the graphical user interface.

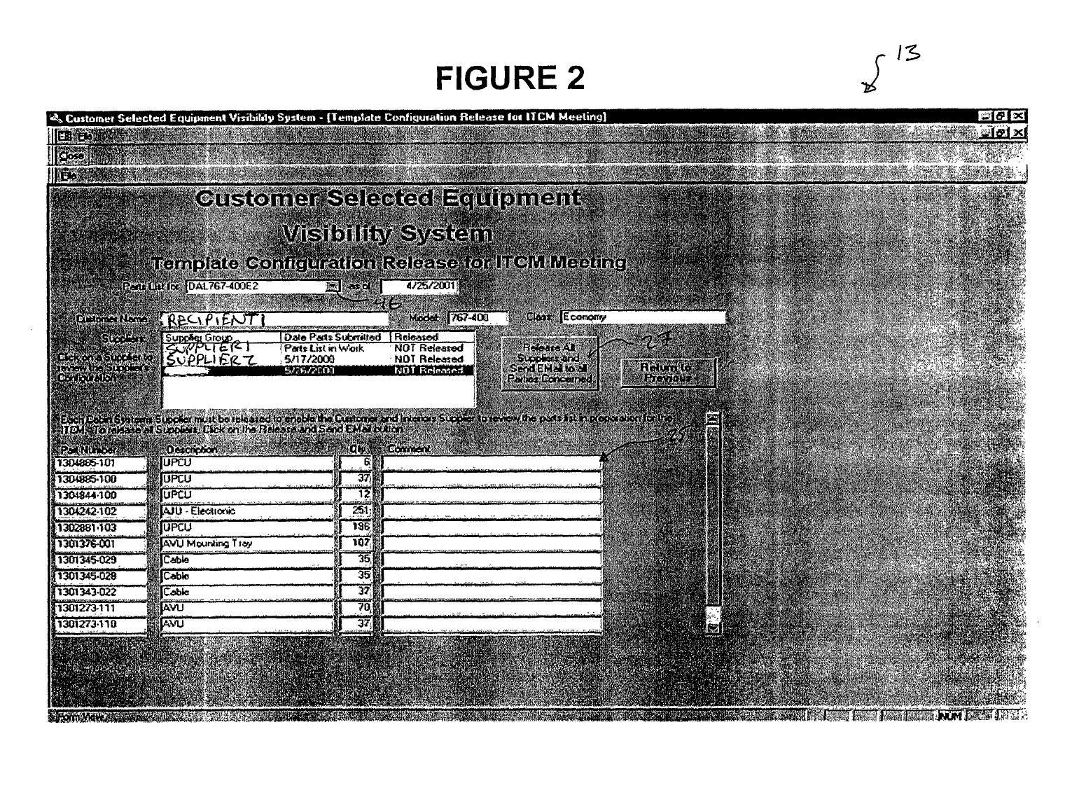

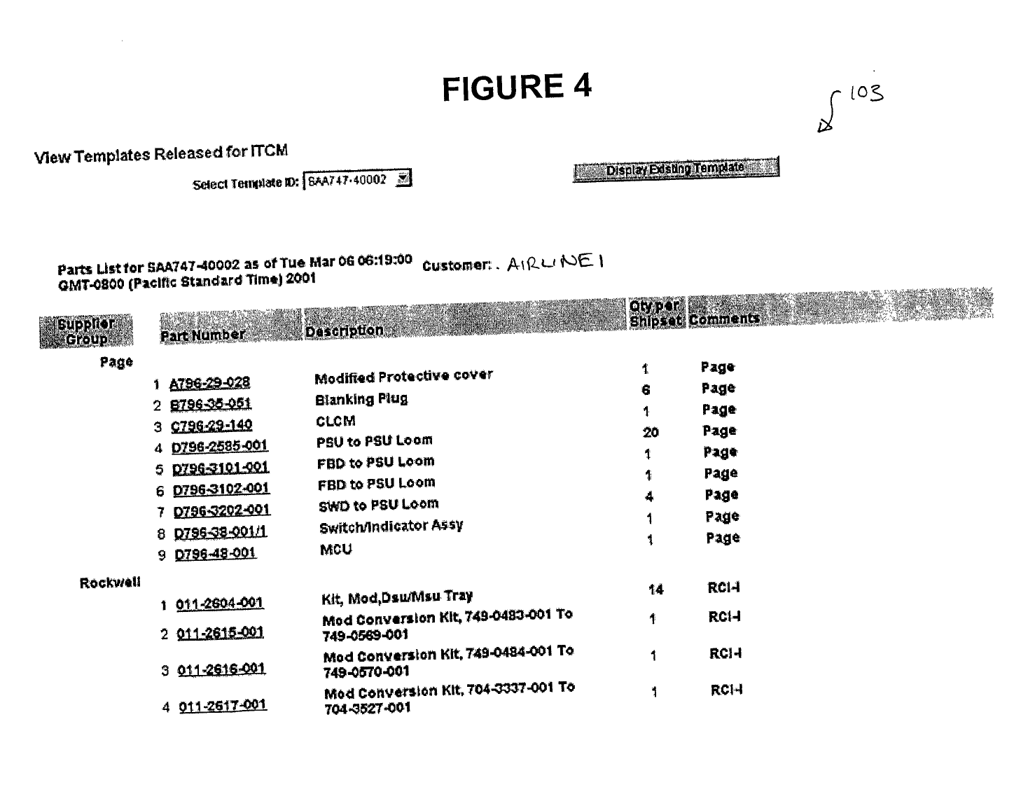

The process coordinated by the supply chain visibility system and method of the present invention, begins prior to an initial technical coordination meeting (ITCM) where a base configuration defining at least a portion of a final assembly is proposed 16, negotiated 28 and agreed upon 24 by the suppliers and the recipient. The proposal is made by releasing a pre-ITCM configuration panel 103 using a pre-ITCM release panel 13 to establish a preliminary configuration for access over the network by the suppliers and recipient, as shown in FIGS. 4 and 2, respectively. Negotiations include a review of the configuration that may result in changes to the configuration. Also, delivery schedules are developed corresponding to the configuration.

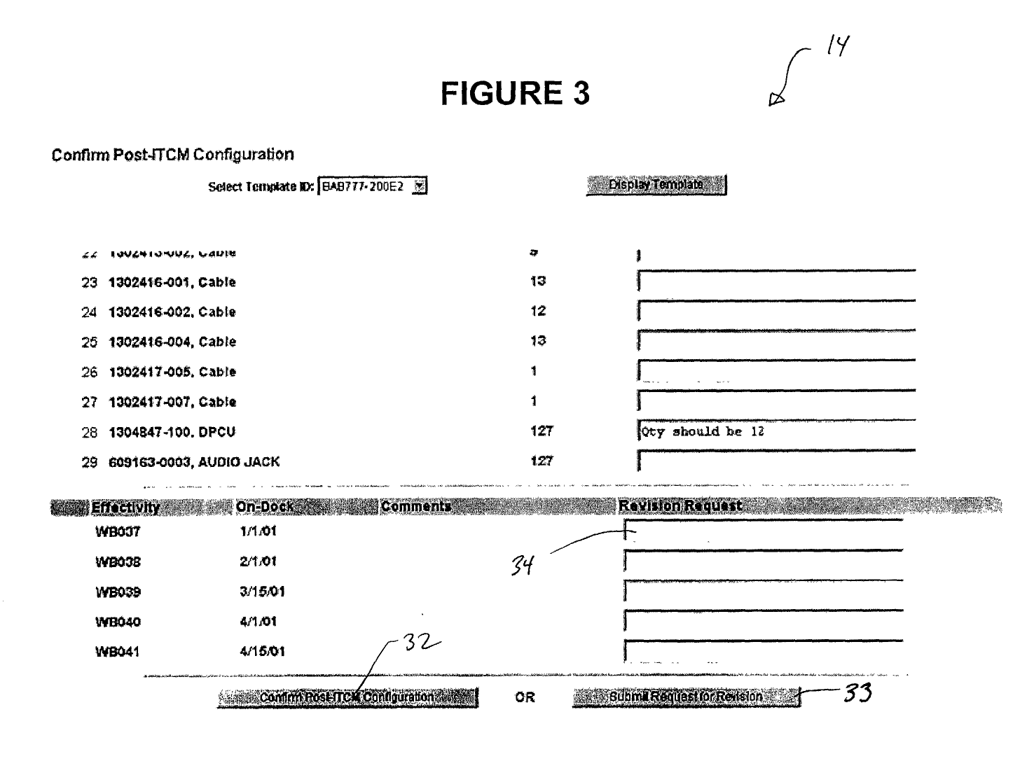

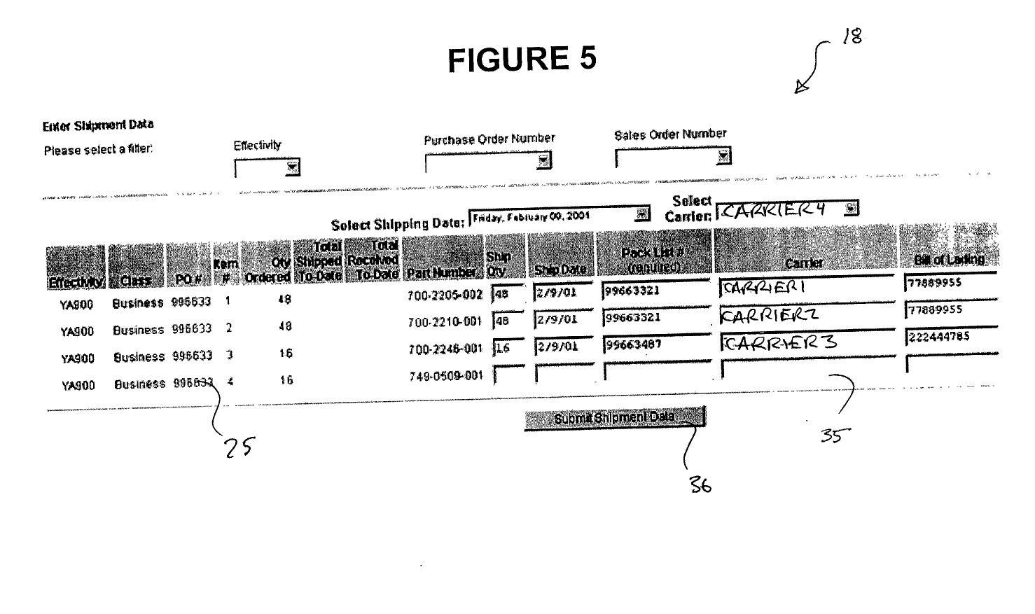

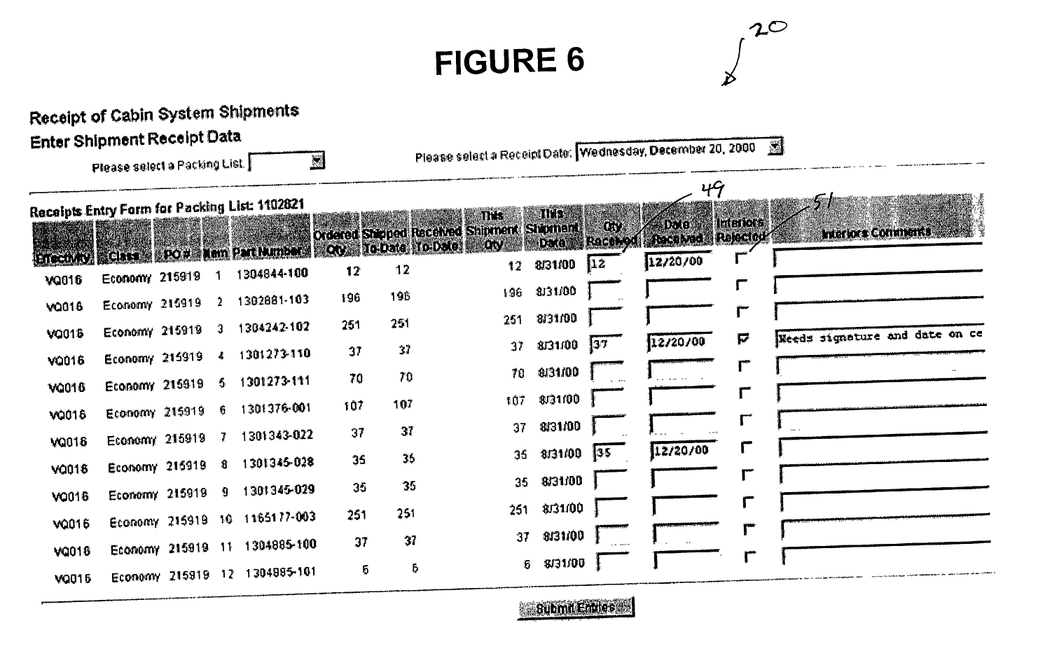

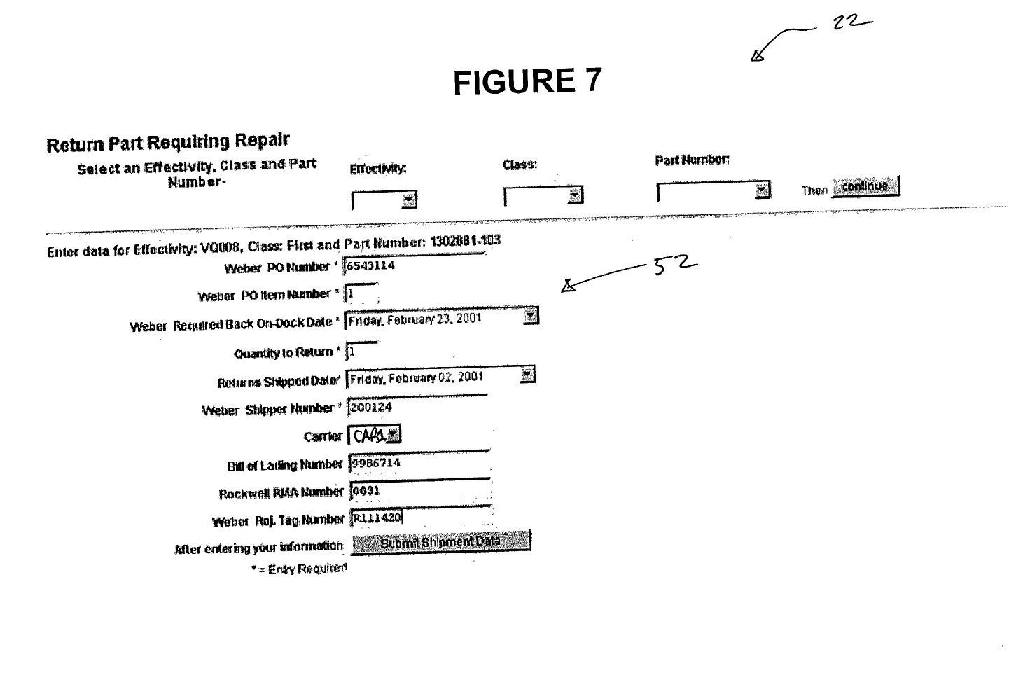

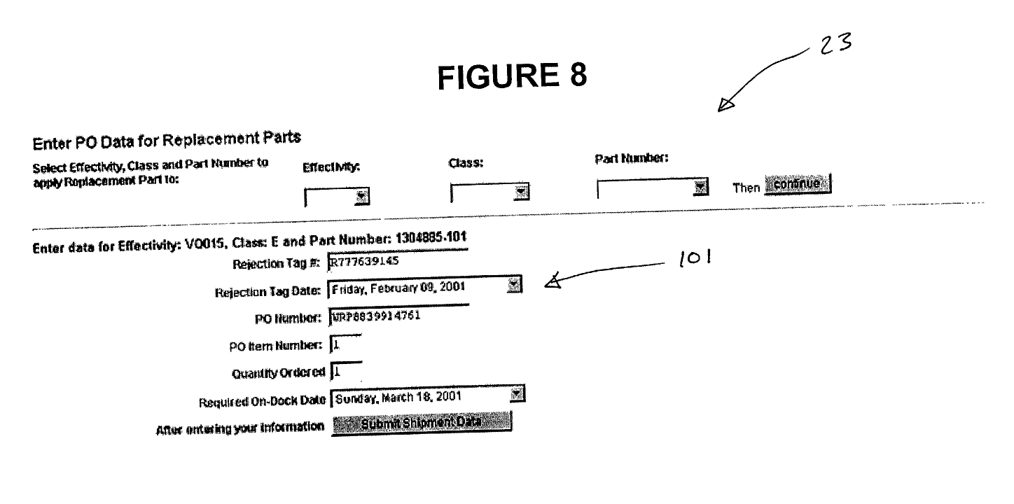

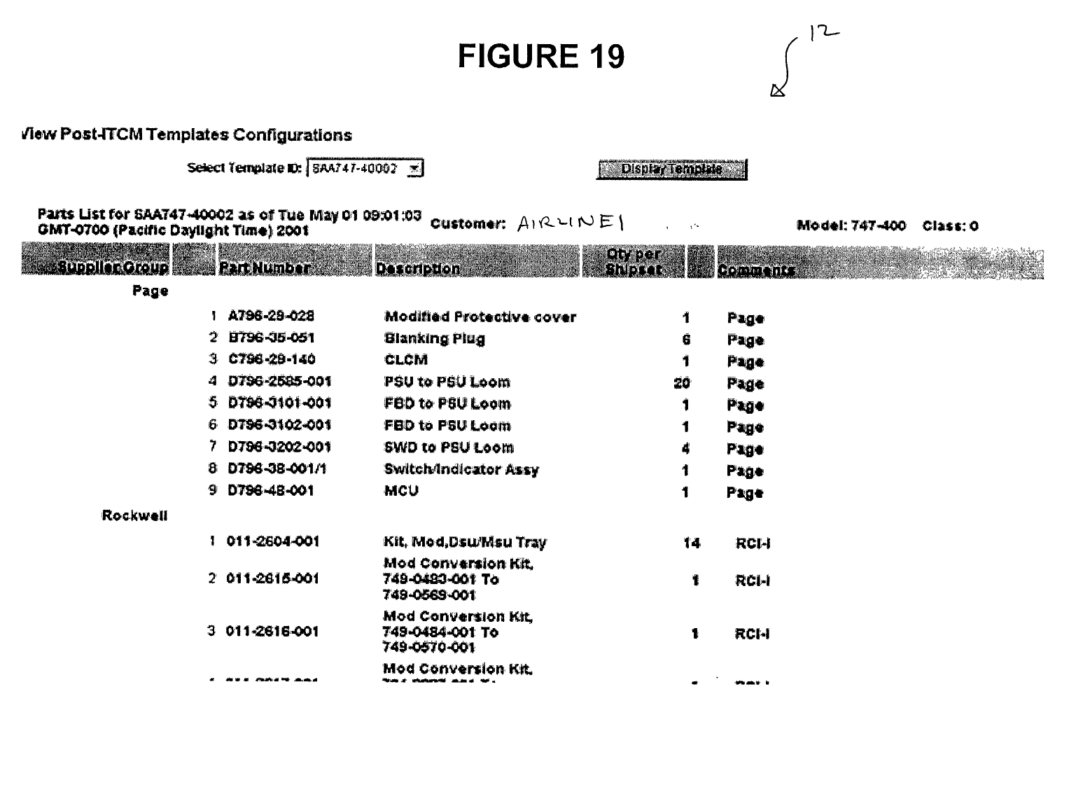

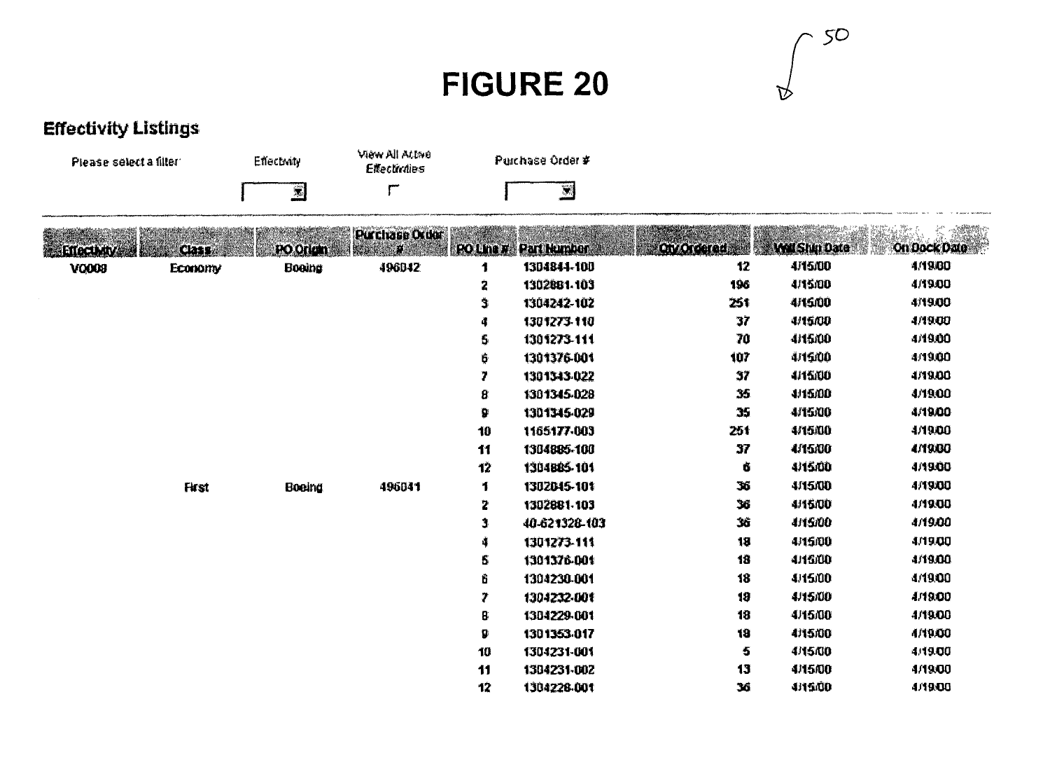

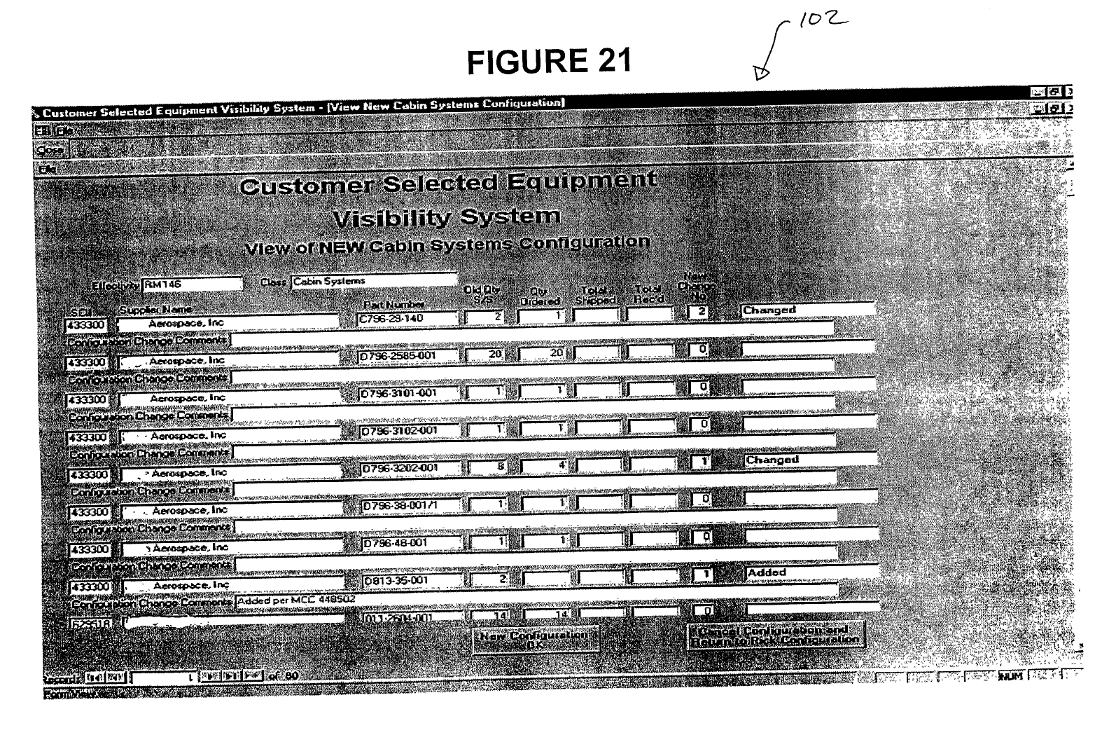

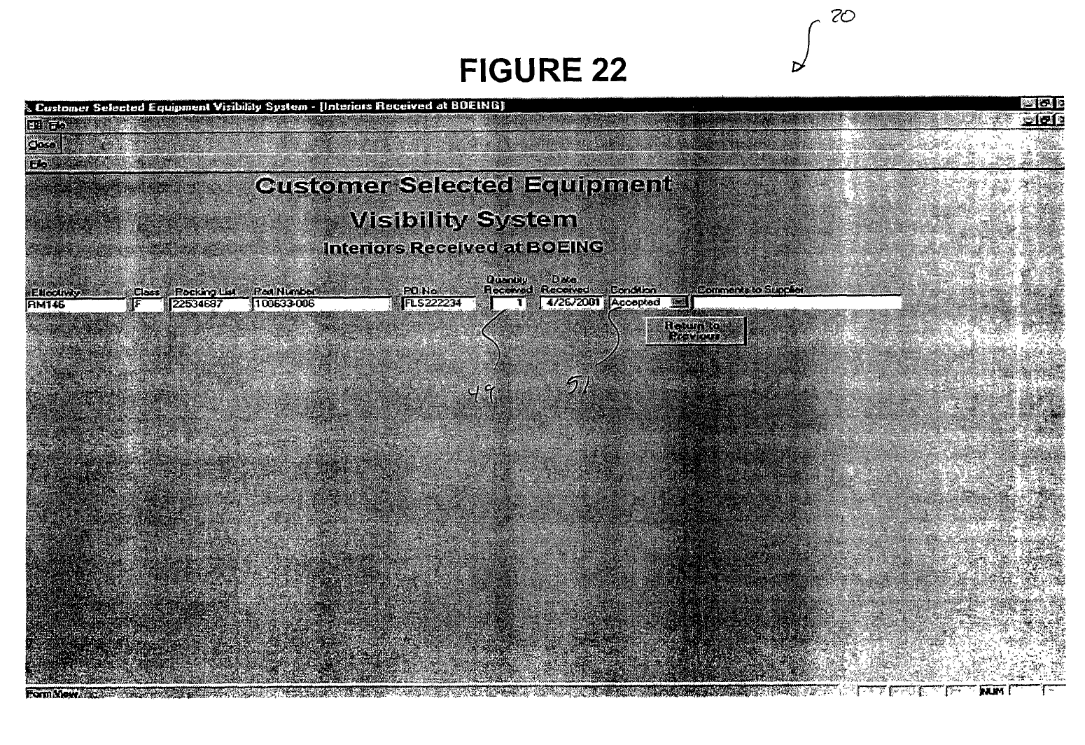

A post-ITCM confirmation panel 14 containing changes from the ITCM meeting is released for final confirmation by the suppliers and recipient, as shown in FIG. 3. Once the base configuration is defined and confirmed using the ITCM process 11, a final template panel 12 containing all of the parts common to each effectivity is generated, as shown in FIG. 19. The template is exploded into a statement of work (SOW) 50 by generating copies of the template and assigning a copy to each of the effectivities, as shown in FIG. 20. The SOW is a listing of every part of every effectivity, from which a purchase order (PO) is released 15 to be filled by the suppliers. The SOW 50 may be changed by the recipient using a SOW configuration change panel 102, as shown in FIG. 21. A supplier ships the parts 17 and enters the shipment data into a shipment data panel 18, as shown in FIG. 5. A recipient receives the shipment 19 and enters receipt data into one of two receipt data panels 20, as shown in FIGS. 6 and 22. The recipient identifies any damage to the parts 21. If any damage is found, or the parts are otherwise unacceptable, the recipient returns the part for repair to the upstream supplier by submitting the part data into a return-for-repair panel 22, or orders an entirely new part using a replacement panel 23, as shown in FIGS. 7 and 8. Each time a change in the status of the order is submitted using one of the panels, the computer system 150 updates the database 100 and the SOW 50 accordingly. Once the proper parts have been received, the recipient assembles the parts into the finished assembly.

Recipient as used herein is not meant to be limiting and could be any person or firm receiving a shipment, such as a customer, a manufacturer hired by a customer, retrofit center under subcontract to the manufacturer, or another supplier in the supply chain. Supplier as used herein can be any person or firm supplying parts or subassemblies for manufacture or construction into the assembly. For example, the supplier may be a cabin systems supplier for an airplane that is shipping parts to a seat supplier (as recipient) that will install the parts into a seat assembly. In turn, the seat supplier becomes the supplier by shipping the seats to the airplane manufacturer (as recipient) to be installed into the airplane. Note that more than one supplier may be in the supply chain and may serve as recipient or supplier depending upon the parts being shipped. In another aspect, the ultimate recipient is a third party customer to the manufacturer who is a supplier to the customer and a recipient from other, upstream suppliers. In this case, the manufacturer employs a PA on behalf of the third party to monitor the supply chain visibility system.

The term “parts” as used herein describes goods in general and can include goods mixed with services (such as installation services). The term goods is not meant to be limiting and could include bulk chemical materials, mechanical parts, electrical parts and other commodities or materials that may be constructed or compounded into an product or assembly. Likewise, the terms assembly and subassembly can be a combination of goods and services and are not restricted to being constructed of mechanical parts. In one aspect, the parts can include test hardware to ensure that certain parts meet specifications, such as government regulations. The parts can also include spares to be used for parts that are frequently lost or damaged.

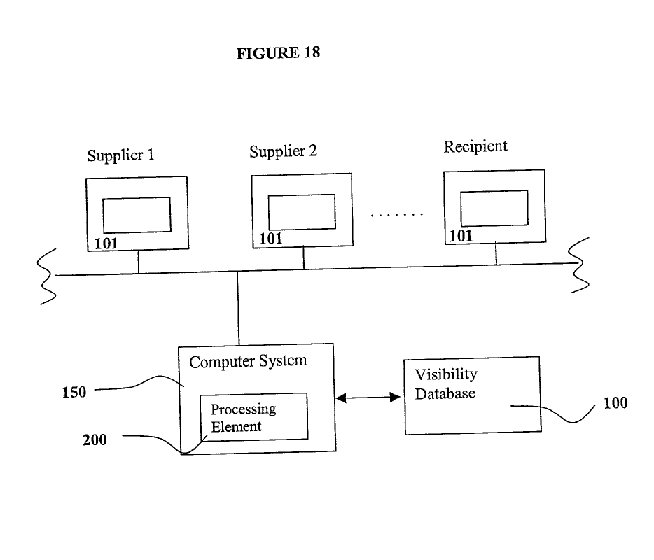

As described herein, the term “panel” refers to a display presented by the graphical user interface of one or more suppliers or the recipient. In one example, the panel can be defined as a web page, or a portion of page including one or more entry fields for the entry of data to the visibility database 100. The computer system 150 generally produces the panels based on data entered by one or more of the participants as described above and/or data stored by the visibility database 100, such as historical data. The computer system 150 then releases or transmits the panels via the network to the respective graphical user interfaces 101 of the participants for display, as shown in FIG. 18. The visibility database itself may be a single server with a storage or some other collection of hardware, software or firmware that stores supply chain data and the current version, or perhaps prior versions, of the various panels provided to the participants according to the present invention. As described, the visibility system typically operates under the direction of the computer system 150 that includes a processing element 200 that again can be comprised of any collection of software, hardware or firmware. In general, the entry fields have several ways of accepting data, such as manual typing, pull-down menus or uploading from data files. Entry fields, panels and graphical user interfaces are well-known in the art and therefore will not be described in any further detail herein.

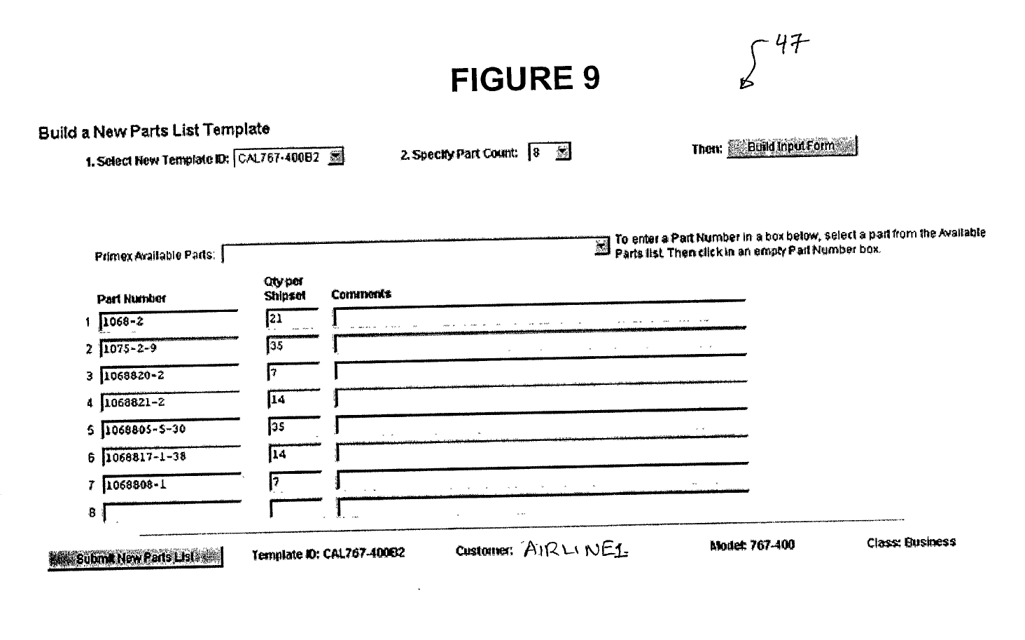

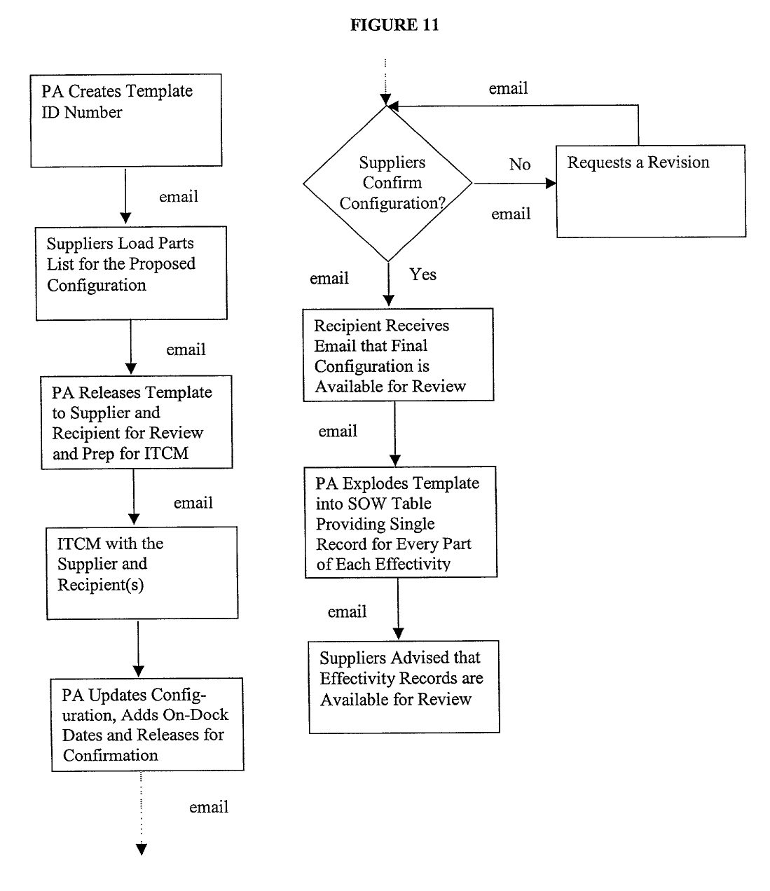

The pre-ITCM stage includes activities that take place prior to the ITCM. The PA creates a template ID number of a template that is to be filled with a list of parts that comprise a proposed configuration, as shown by the flowchart of FIG. 11. One or more of the suppliers load the proposed configuration into the new parts list panel 47, as shown in FIG. 9. The supplier may add new parts to, or delete parts from, an existing template that has a similar configuration. Reusing an previous configuration reduces the effort associated with multiple entries of the same parts.

The PA releases the proposed configuration prior to the ITCM using the pre-ITCM release panel 13. The pre-ITCM release panel has a template ID field 46, a plurality of parts list fields 25 and a release button 27, as shown in FIG. 2. The PA selects the desired template ID number in the template ID field 46 to reveal the proposed configuration. The proposed configuration associated with the selected template ID number is listed in a plurality of the part list fields 25. The part list fields list the details of each part including serial number, description, quantity and additional comments. The PA reviews the configuration, making any necessary modifications and releases the proposed configuration by selecting a release button 27 on the pre-ITCM release panel 13. The proposed configuration is then accessible by the suppliers and recipient over the network in the form of the pre-ITCM configuration panel 103, thereby allowing the suppliers and recipient to review the proposed configuration in preparation for the ITCM, as shown in FIG. 4. In this regard, the contents of the pre-ITCM configuration panel defining the proposed configuration are typically stored by the visibility database 100. Advantageously, the release of the proposed configuration ensures that each of the parties to the ITCM is adequately informed and ready to negotiate the final configuration and its delivery schedule.

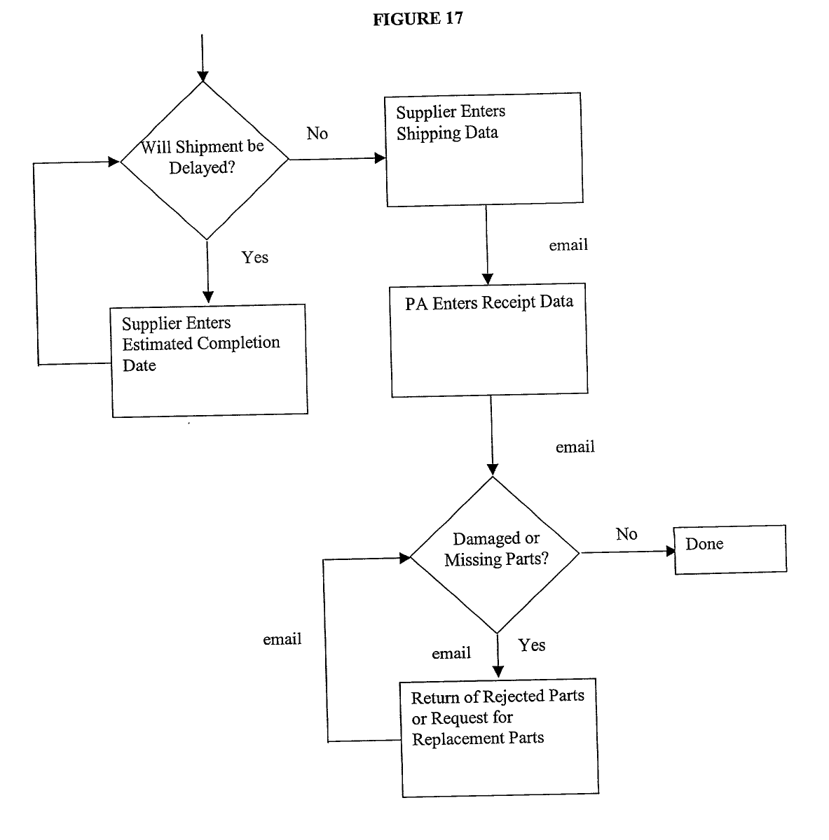

The entry of the proposed configuration, release of the proposed configuration and all other entries or changes submitted to the database 100 via the graphical user interfaces 101 of the PA or the suppliers are accompanied by an email notification generated by the computer system, as shown in FIGS. 11 and 17. The email notification is dispatched to each of the interested parties (suppliers and recipients) if they are deemed privy to the information by the PA or other supervising agent to protect any confidential information. The email may contain a notice of the entries, a listing of the results of the entries, or a link or links to the panel detailing the entries, such as the entries using the pre-ITCM release panel 13. Advantageously, the email notifications ensure that each of the parties is immediately informed of changes. Such immediate notification accelerates the ability of the parties to incorporate the information into their work plans resulting in an increase in production efficiency. The emails therefore maintain open communication throughout the supply chain.

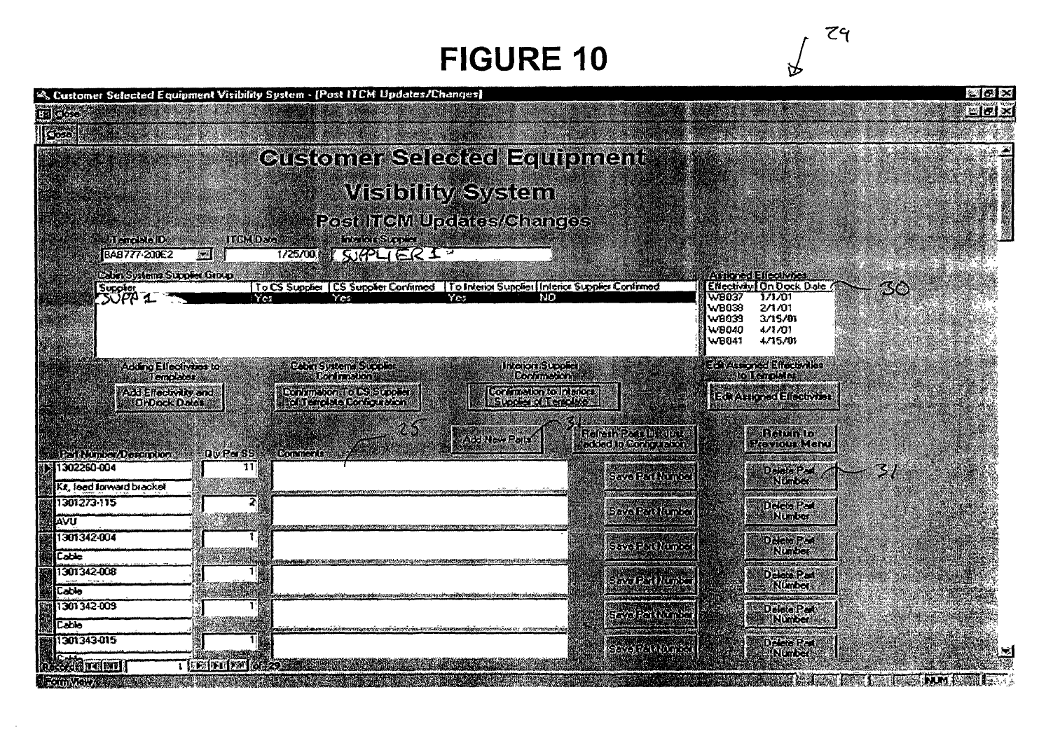

During the ITCM negotiation step 28, which is typically conducted by conference, the proposed configuration is reviewed and negotiated. Delivery schedules associated with each configuration are also proposed during the negotiations. An agreement on a base configuration is reached 24, and the configurations are finalized by template ID number. Prior to the ITCM the suppliers are able to change the configuration as desired, but after the ITCM the suppliers must submit changes by request. Only the recipient can actually change or update the configuration. Updates and changes after the ITCM are entered by the PA using a post-ITCM update panel 29, as shown in FIG. 10. The update panel 29 includes a date field 30 for the input of delivery, or “on dock,” dates next to each of the parts list fields 25. The dates entered are those dates that were determined during the ITCM. The update panel 29 also includes addition and deletion buttons 31 to add and delete parts and part numbers as desired.

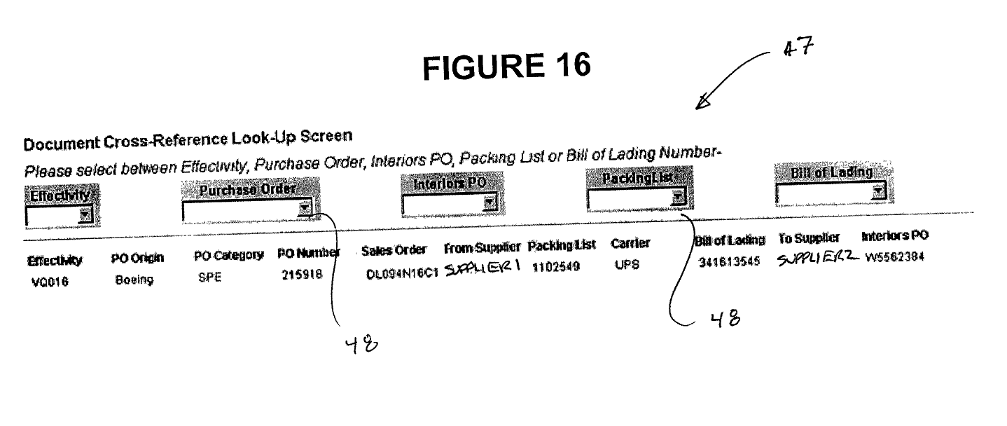

Release of the update panel 29 generates the post-ITCM confirmation panel 14. Each supplier is asked via the confirmation panel to confirm that the revised configuration and the delivery dates are correct according to the agreements made during the ITCM, as shown in FIG. 3. The supplier may either confirm the configuration by selecting a confirmation button 32, or may request a revision by entering the request in a revision request field 34 and selecting a request for revision button 33. The proposed revisions are submitted to the PA, and the suppliers are notified of such by an email. When the requested changes are resolved, the PA contacts the supplier who submitted the request and resends the post-ITCM confirmation panel 14 for final confirmation by the supplier. The final configuration is set by the PA after all confirmations have been received and the final template panel 12 is released and distributed, as shown in FIG. 19. The computer system then explodes final template into the SOW table 50 maintained by the database 100 which provides a single record for every part of each effectivity, as shown in FIG. 20. The computer system 150 then distributes purchase orders to the suppliers or the purchase orders downloaded from the SOW table by the suppliers in preparation for shipping of the parts listed. Parts on the SOW table 50, and other parts on the database 100, can be listed by one or more effectivities, by purchase order or by cross-reference using a cross-reference panel 47 that is also maintained by the visibility database, as shown in FIG. 16. The cross-reference panel allows the supplier or recipient to look up the parts using a plurality of cross-reference selection fields 48. Preferably, the cross-reference selection fields allow the user to look up the parts grouped by PO number, bill of lading number, packing list number and sales order number. In addition to viewing part listings on the SOW table 50, the part listings can be changed by the PA using a SOW configuration change panel 102, as shown in FIG. 21.

In reference to the shipment process flow diagram shown in FIG. 17, the suppliers preferably enter shipment data soon after a carrier picks up the shipment. Entering the shipping information in a timely matter is particularly important for a shipment that is delinquent or requested on an expedited basis. Shipment data is entered into the shipment data panel 18, as shown in FIG. 5. The shipment data panel 18 includes part list fields 25 and shipment information fields 35. The shipment information fields are correlated with each of the parts and preferably include information on a quantity shipped, a shipment date, a packing list number, a carrier used and a bill of lading number. Shipment data can be entered by the supplier using effectivity or purchase order number of the part. A submit shipment data button 36 submits the shipment data to the database 100. A confirmation message (not shown) confirms that the data was submitted. The supplier is warned if the quantity shipped exceeds the quantity ordered. The processing element 200 then compares the entered shipment data to the configuration data listed in the database, allocates the shipment data to its respective effectivity and updates the configuration data. Confirmation emails are sent to involved suppliers and recipient that shipment data was entered.

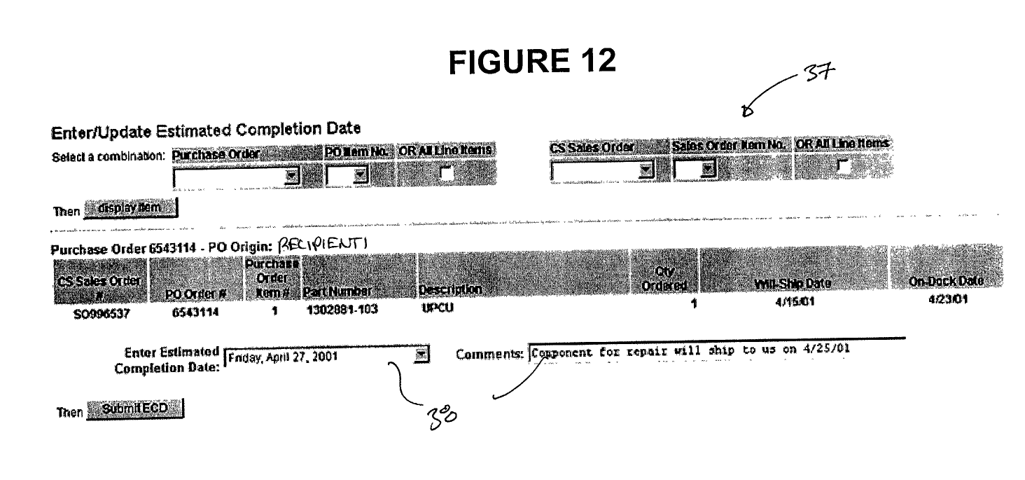

If there are problems with fulfilling the purchase order in a timely manner, the supplier can enter an estimated completion date (ECD) into an ECD panel 37, as shown in FIG. 12. The supplier can display a particular part and enter an estimated completion date with comments on the completion date or part into an ECD field 38. Submission of ECD information updates the database 100 and send an email alert to the appropriate parties. Because the shipping dates have a direct bearing on work flow, rapid and effective communication of a change in the shipping dates is also important. Such notice allows rearrangement of work orders and other logistics or workarounds to ensure efficient production flow.

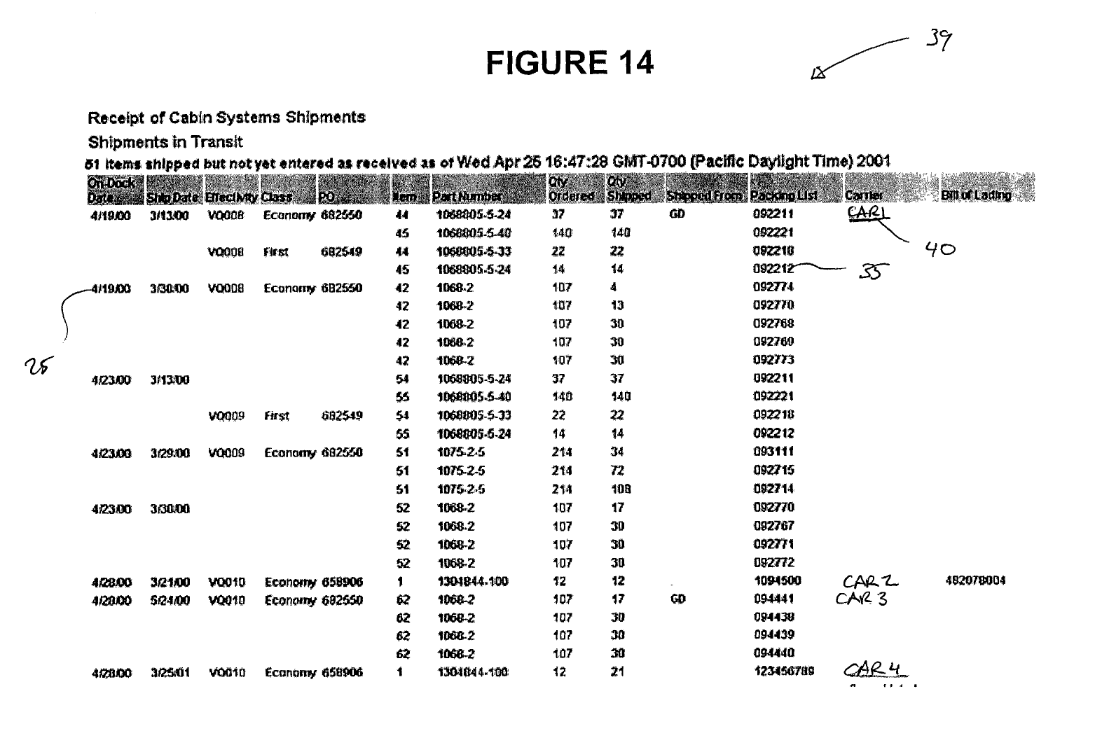

The suppliers and recipient can view all parts that were shipped but not received using a shipments in transit panel 39, as shown in FIG. 14. The shipment in transit panel lists all parts using part list fields 25 correlated with shipment information fields 35. The shipment information fields preferably contain information on the on-dock date, the ship date, a shipped from location, a packing list, a carrier and a bill of lading that are generated by the computer system 150 using data from the database 100 and the graphical user interfaces 101. The data is sorted by on-dock date to generate an exception report, as the shipment that is the most behind is typically the most critical. The name of the carrier includes a carrier hot-link 40 to a panel (not shown) having contact information, including a phone number, of the carrier's local office. The hot-link facilitates follow-up on late or critical shipments that are still in transit. Exception reports are useful because only the relatively few parts that are late have to be viewed, not the thousands of parts that are not late.

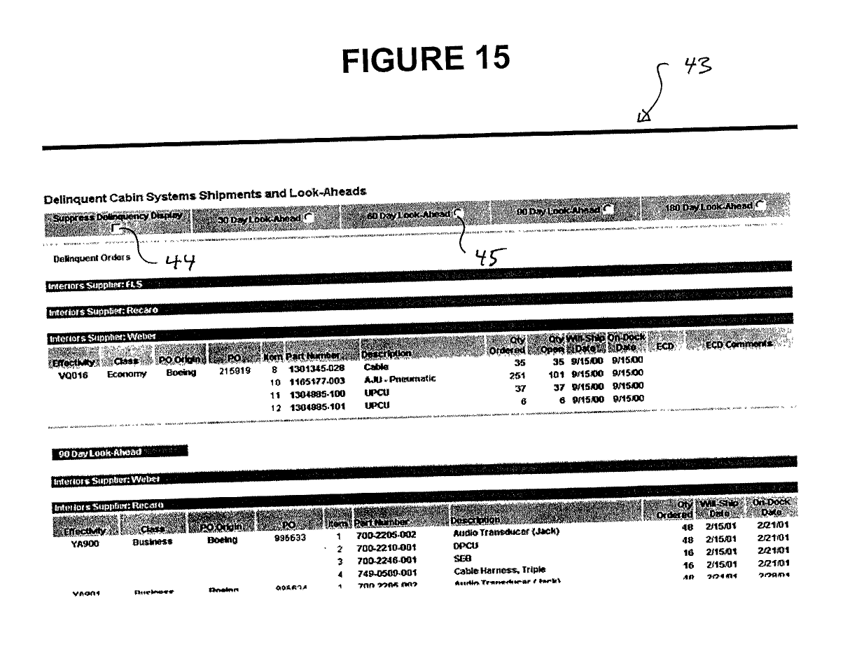

The suppliers and recipient can also view delinquent shipments and look ahead into what shipments are due in the future using a delinquent and look-ahead panel 43, as shown in FIG. 15. The delinquent panel 43 has a delinquency selection field 44 and look-ahead selection fields 45 that allows the user to select whether to view delinquencies, or look-ahead parts listings for 30, 60, 90 and 180 day increments. The delinquencies and look-ahead listings can also be viewed in a single list. The deliquencies and look-ahead listings are generated by the processing element 200 from data on the shipping dates entered via the shipment data panel 18 one of the receipt data panels 20.

Referring again to FIG. 17, the PA enters receipt data upon receipt of the shipment. The recipient updates the database 100 with the receipt data by completing and releasing one of the receipt data panels 20, as shown in FIG. 6. The receipt data panels include a plurality of receipt data fields 49 for the input of a quantity of the part received, date received and any comments on the shipment. The panels 20 also include a rejection selection box 51 that the recipient may use to reject a group of parts, as shown in FIGS. 6 and 22. The rejection selection box allows the computer system 150 that sends an email back to the shipper, whether the part is rejected or not, to warn the shipper of the rejection.

If the parts are damaged or missing, the recipient has the option of either returning the part for repair as documented by the return for repair panel 22 or ordering a replacement part as documented by the replacement part panel 23, as shown in FIGS. 7 and 8, respectively. The return for repair panel 22 includes a plurality of return fields 52 that allow the recipient to identify the part, a return shipment date and a back-on-dock date. The back-on-dock date is the date by which the recipient wishes to receive the repaired part. The replacement part panel 23 includes a plurality of replacement fields 101 that identify the part and the rejection. Submission of the repair and replacement panels 22, 23 by the recipient updates the database 100 accordingly.

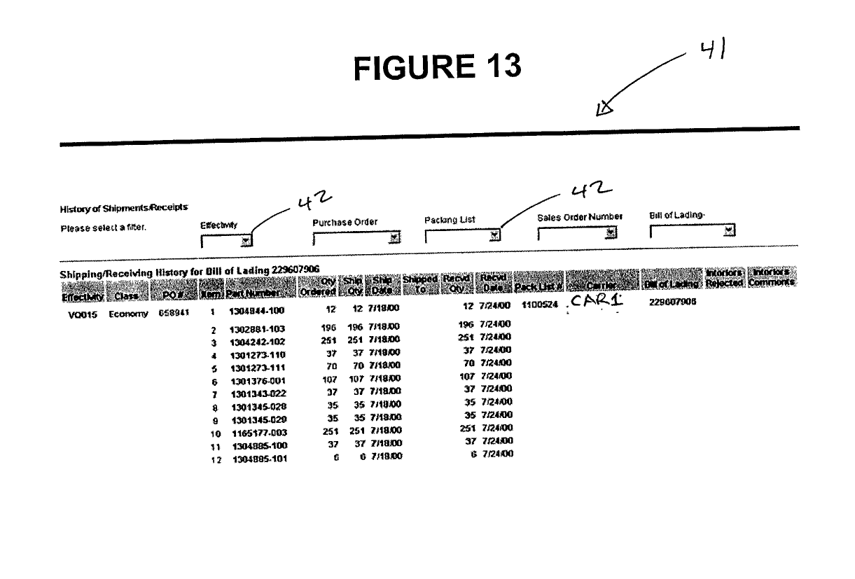

A listing of all shipments and receipts is available through a shipping and receiving history panel 41, as shown in FIG. 13. The shipping histories of various part listings are available through a group of selection menus 42 that preferably include effectivity, purchase order, packing list, sales order number and bill of lading fields. Selection of one of the selection menus 42 causes the computer system 150 to automatically generate the part list type selected. For instance, the user selects an effectivity number from the menus 42 and all shipped and received parts for that effectivity are listed on the history panel 41.

The supply chain visibility system and method 10 of the present invention have several advantages. Improved visibility and real-time updates of the shipping status of various parts allows better management of the supply chain. The system advantageously combines both the creation of a configuration and the tracking of the parts of the configuration in a single system widely accessible over a network by a plurality of users. Delinquent and in transit parts can be easily identified to improve organization of work flow by the recipient and suppliers. Heads-up communication is ensured by email notification after every change or entry using the supply chain visibility system.

Many modifications and other embodiments of the invention will come to mind to one skilled in the art to which this invention pertains having the benefit of the teachings presented in the foregoing descriptions and the associated drawings. For example, in one aspect of the supply chain visibility system and method 10 the supplier may upload data from its own database into the database 100. An automated upload saves the effort required to enter the data by hand and reduces the number of errors from errant keystrokes. In yet another aspect, the present invention may include security features to restrict users of the system to a limited set of records to protect confidential information. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A supply chain visibility system operably connected to a network for coordinating a supply chain of a plurality of parts to be assembled into a finished assembly for each of a plurality of effectivities, said parts supplied by a plurality of suppliers and received by at least one recipient, the supply chain visibility system comprising:
a plurality of graphical user interfaces associated with respective suppliers and the recipient and interconnected via the network, each graphical user interface capable of presenting:
a configuration panel operable to display a final configuration agreed to by the suppliers and the at least one recipient, said final configuration defining at least a portion of the finished assembly for which the parts need to be shipped;
a template panel operable to display a common set of parts that are common to each of the plurality of effectivities, the common set of parts being those parts necessary to assemble the final configuration;
a statement of work panel for each effectivity, each statement of work panel operable to display a final set of parts derived from the common set of parts, said statement of work panel also operable to display a shipping status of the final set of parts; and
a shipment entry panel configured to receive shipping status data from the suppliers and the recipient, said shipping status data usable to update the shipping status of the final set of parts; and
a processing element comparing the shipping status data received by the shipment entry panel to the shipping status of the final set of parts and updating the shipping status of the parts so that the suppliers and the recipient have an ongoing view of the shipping status of the final set of parts to permit assembly of the finished assembly to be planned accordingly.

2. The supply chain visibility system of claim 1, further comprising an electronic mail dispatch system operable to dispatch electronic mail messages to the suppliers and the recipient, the electronic mail messages relating changes and entries submitted to via the graphical user interface.

3. The supply chain visibility system of claim 1, wherein the statement of work panel includes a plurality of fields displaying the shipping status of the final set of parts, said shipping status including a part number and an effectivity listing of each of the final set of parts.

4. The supply chain visibility system of claim 3, wherein the shipping status further includes discrepancy information on parts received but found to be inadequate by at least one of the recipient and the receiving supplier.

5. The supply chain visibility system of claim 3, wherein each graphical user interface further comprises a return part panel configured to receive repair information on parts being returned to one of the suppliers for repair.

6. The supply chain visibility system of claim 5, wherein said statement of work panel is configured to receive the repair information from the return part panel and to display the repair information.

7. The supply chain visibility system of claim 3, wherein each graphical user interface further comprises a replacement part panel configured to receive information on parts that need to be replaced.

8. The supply chain visibility system of claim 7, wherein said statement of work panel is configured to receive the replacement information from the replacement part panel and to display the replacement information.

9. The supply chain visibility system of claim 1, wherein each graphical user interface further comprises a shipments in transit panel operable to display the shipping status of parts sent by the suppliers but not yet received.

10. The supply chain visibility system of claim 9, wherein said shipments in transit panel includes a link to contact information for a carrier to which the parts were submitted for shipment.

11. The supply chain visibility system of claim 1, wherein each graphical user interface further comprises an estimated completion date panel configured to receive a revised completion date for supply of at least one of the parts and to add the revised completion date to the shipping status of the statement of work panel.

12. The supply chain visibility system of claim 1, wherein each graphical user interface further comprises a delinquency panel configured to display a list of late parts that have failed to arrive by a due date.

13. The supply chain visibility system of claim 1, wherein each graphical user interface further comprises a proposed configuration panel operable to display a proposed configuration agreed to by at least one supplier.

14. The supply chain visibility system of claim 13, wherein each graphical user interface further comprises a configuration release panel operable to change the proposed configuration, add due dates for the proposed configuration and finalize the proposed configuration into the final configuration.

15. The supply chain visibility system of claim 14, further comprising an electronic mail dispatch system operable to dispatch electronic mail messages relating to the proposed configuration and the final configuration.

16. A method of coordinating a supply chain of a plurality of parts to be assembled into a finished assembly for each of a plurality of effectivities, said parts supplied by a plurality of suppliers and received by at least one recipient, each of the plurality of suppliers and the at least one recipient having a graphical user interface that is connected to and supplied information via a network, said method comprising:
displaying, using a configuration panel of each graphical user interface, a final configuration that defines a portion of the finished assembly for which the parts need to be shipped;
displaying, using a template panel of each graphical user interface, a common set of parts that are common to each of the plurality of effectivities, the common set of parts being those parts necessary to assemble the final configuration;
generating a final set of parts by applying the common set of parts across each of the plurality of effectivities;
displaying, using a statement of work panel of each graphical user interface, a shipping status of the final set of parts; and
receiving shipping status data from the suppliers and the recipient and updating the shipping status of the final set of parts so that the suppliers and the recipient have an ongoing view of the shipping status of the final set of parts to permit assembly of the finished assembly to be planned accordingly.

17. The method of claim 16, further comprising dispatching an electronic mail message to one of the suppliers and the recipient, the electronic mail messages relating changes and entries submitted to via the graphical user interface

18. The method of claim 16, wherein displaying the shipping status includes displaying a part number, a shipping date, and a receipt date of each of the final set of parts.

19. The method of claim 18, wherein displaying the shipping status further includes displaying discrepancy information on parts received but found to be inadequate by at least one of recipient and the receiving supplier.

20. The method of claim 18, further comprising receiving repair information on parts being returned to one of the suppliers for repair using a return part panel of each graphical user interface.

21. The method of claim 20, further comprising receiving, using the statement of work panel, the repair information from the return part panel and displaying the repair information.

22. The method of claim 18, further comprising receiving, using a replacement part panel of each graphical user interface, information on parts to be replaced.

23. The method of claim 22, further comprising receiving, using the statement of work panel, the replacement information from the replacement part panel and displaying the replacement information.

24. The method of claim 16, further comprising displaying, using a shipments in transit panel, the shipping status of parts sent by the suppliers but not yet received.

25. The method of claim 16, further comprising receiving revised completion dates, using an estimated completion date panel of each graphical user interface, and displaying the revised completion date using the statement of work panel.

26. The method of claim 16, further comprising displaying, using a delinquency panel of each graphical user interface, a list of late parts that have not been delivered by a due date.

27. The method of claim 16, further comprising displaying, using a proposed configuration panel of each graphical user interface, a proposed configuration agreed to by at least one supplier.

28. The method of claim 27, further comprising changing the proposed configuration, adding due dates for the parts of the proposed configuration, and finalizing the proposed configuration into a final configuration using a configuration release panel of each graphical user interface.

29. The method of claim 28, further comprising dispatching an electronic mail message relating to the proposed configuration and the final configuration.
